(19) United States
(12) Patent Application Publication
(10) Pub. No.: US 2017/0263901 A1
(43) Pub. Date: Sep. 14, 2017

(54) BATTERY MODULE

(71) Applicant: Panasonic Intellectual Property Management Co., Ltd., Osaka (JP)

(72) Inventors: DAISUKE KISHII, Osaka (JP); TOMOHIKO YOKOYAMA, Osaka (JP)

(21) Appl. No.: 15/310,174

(22) PCT Filed: Jun. 18, 2015
(86) PCT No.: PCT/JP2015/003051

§ 371 Date: Nov. 10, 2016

(30) Foreign Application Priority Data
Jul. 22, 2014 (JP) 2014-148438

(51) Int. Cl. H01M 2/02

(52) U.S. Cl. CPC H01M 2/0242

(57) ABSTRACT

A first battery holder and second battery holder are stored in a battery case so as to be adjacent to each other. The first battery holder and second battery holder are wholly rectangular in a plan view. The first battery holder includes a cutout portion on its one edge facing the second battery holder. The same is true for the second battery holder. The cutout portion of the first battery holder and the cutout portion of the second battery holder are disposed so as to be adjacent to each other.

### TECHNICAL FIELD

The present invention relates to a battery module including a plurality of battery blocks stored in a battery case.

### BACKGROUND ART

As a power source for driving a motor of an electric car or the like, or as a power source for household use or industrial use, a battery module formed in the following manner is employed. A battery block is formed by interconnecting cells such as lithium-ion cells in parallel, and a battery module is formed by interconnecting a plurality of battery blocks in series or in parallel. Patent Literature 1 discloses a technology in which a battery holder storing cells includes an elastically deformable member and hence the resistance to an external impact on the battery holder is improved.

### CITATION LIST

### Patent Literature

PTL 1: Unexamined Japanese Patent Publication No. 2013-73845

### SUMMARY OF THE INVENTION

In the technology disclosed by Patent Literature 1, the range capable of absorbing the external impact is within the deformable range of an elastically deformable member. Therefore, when an external impact that exceeds the deformation amount of the elastically deformable member is applied, disadvantageously, the impact arrives at the cells and the cells are internally short-circuited.

The present invention provides a battery module that can suppress the breakage and internal short-circuit of the cells due to an external impact.

A battery module of the present invention includes the following components:

a first battery block including: a first battery holder having a plurality of through holes; and cells stored in the plurality of through holes, respectively;

a second battery block including: a second battery holder having a plurality of through holes; and cells stored in the plurality of through holes, respectively; and

a battery case for storing the first battery block and second battery block so that they are adjacent to each other.

The first battery block and second battery block are stored in the battery case so that the longitudinal direction of the cells stored in the first battery holder and the longitudinal direction of the cells stored in the second battery holder are the same. The first battery holder is wholly rectangular in a plan view from the longitudinal direction of the cells. In the plan view, the first battery holder includes a first cutout portion having a shape that is obtained by cutting the corner formed of one edge facing the second battery holder and another edge. The second battery holder is wholly rectangular in the plan view. In the plan view, the second battery holder includes a second cutout portion having a shape that is obtained by cutting the corner formed of one edge facing the first battery holder and another edge. The first cutout portion and second cutout portion are disposed so as to be adjacent to each other.

In the battery module of the present invention, the breakage and internal short-circuit of the cells due to an external impact can be suppressed.

### BRIEF DESCRIPTION OF DRAWINGS

FIG. 1 is a perspective view showing the appearance of a battery module.

FIG. 2 is an exploded perspective view of the battery module.

FIG. 3 is a perspective view of a configuration included in the battery module.

FIG. 4 is a side view of the configuration included in the battery module.

FIG. 5 is a sectional view of a cell.

FIG. 6 is a top view of the configuration included in the battery module.

FIG. 7 is a conceptual diagram illustrating a dispersed state of an external force.

FIG. 8 is a conceptual diagram illustrating another dispersed state of the external force.

FIG. 9 is a conceptual diagram illustrating yet another dispersed state of the external force.

FIG. 10 is a reference diagram.

### DESCRIPTION OF EMBODIMENTS)

Hereinafter, an example of an exemplary embodiment of the present invention is specifically described with reference to the accompanying drawings. In referred drawings, the same component is denoted with the same reference mark. In principle, duplicate description of the same component is omitted.

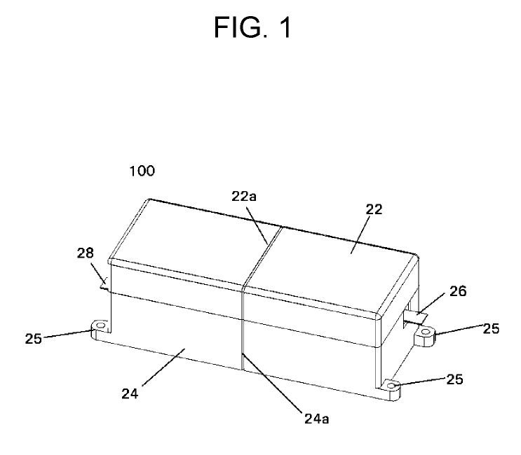

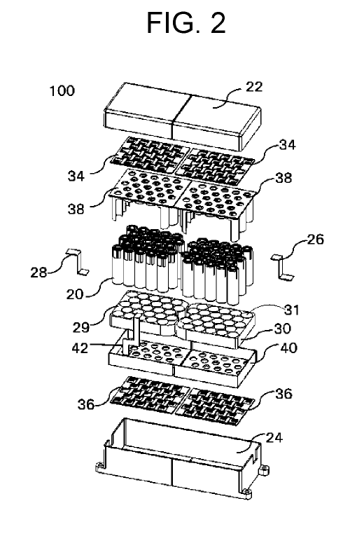

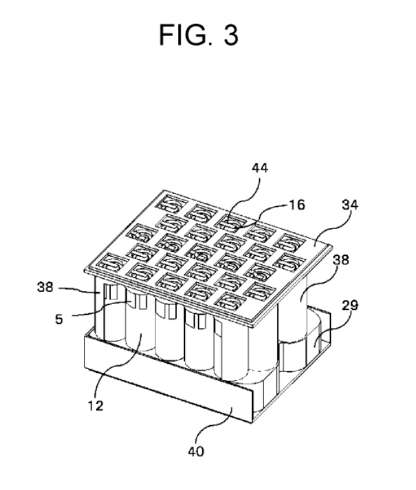

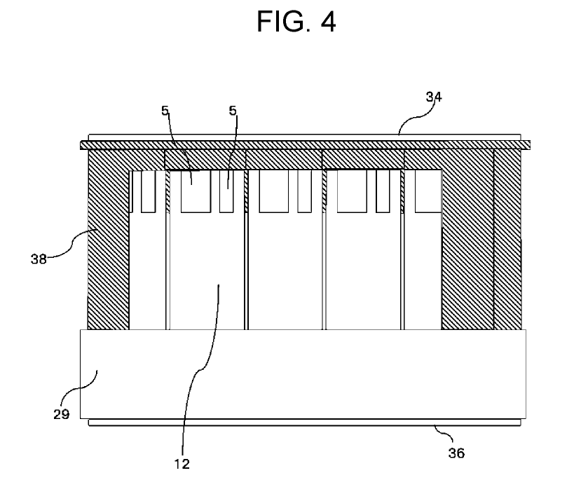

FIG. 1 is a perspective view showing the appearance of battery module 100. FIG. 2 is an exploded perspective view of battery module 100. FIG. 3 is a partial perspective view of a configuration included in battery module 100. FIG. 4 is a partial side view of the configuration included in battery module 100. The shaded area of FIG. 4 is positive-side insulating component 38.

Battery module 100 includes cells 20, first battery holder 29, second battery holder 30 in a battery case formed of upper case 22 and lower case 24. Hereinafter, a battery holder means first battery holder 29 and second battery holder 30. Upper case 22 includes thin-wall portion 22a. Lower case 24 includes thin-wall portion 24a. Positive electrode terminal 26 and negative electrode terminal 28 are projected through openings in lower case 24. Lower case 24 includes four fixing portions 25. Battery module 100 is fixed, via fixing portions 25, to an installation surface that is disposed in the casing of a member or power storage system on the vehicle body side. Attachment tools such as bolts are attached to fixing portions 25.

The battery holder is made of a material of a high thermal conductivity. The battery holder is mainly made of aluminum, and can be molded by extrusion molding. The battery holder includes a plurality of through holes 31 for storing a plurality of cells 20. The plurality of through holes 31 are arranged in a staggered format (zigzag pattern). The battery holder is used for fixing the plurality of cells 20 and heat-equalizing the plurality of cells 20. When these objectives can be achieved, the height of the battery holder in the longitudinal direction of cells 20 does not need to be a height enough to cover the whole side surfaces of cells 20. Especially, a caulked portion of exterior can 5 of each cell 20 does not need to be covered with the battery holder.

A battery block includes one battery holder and a plurality of cells 20, and obtains a predetermined capacity by interconnecting the plurality of cells 20 in parallel. In the present exemplary embodiment, 25 cells 20 are combined with one battery holder to form a battery block. In the battery holder, 25 cells 20 are arranged in a staggered format, and are held while the positive electrodes of cells 20 are aligned to one side and the negative electrodes of cells 20 are aligned to the other side.

In the battery block, positive-electrode current collection plate 34 is disposed on the positive side of cells 20, and negative-electrode current collection plate 36 is disposed on the negative side of cells 20. Positive-electrode current collection plate 34 is electrically connected to positive electrode terminal 26, and negative-electrode current collection plate 36 is electrically connected to negative electrode terminal 28. Positive-side insulating component 38 is disposed between cells 20 and positive-electrode current collection plate 34. Negative-side insulating component 40 is disposed between cells 20 and negative-electrode current collection plate 36. Each of positive-side insulating component 38 and negative-side insulating component 40 has openings in the parts corresponding to the electrodes of cells 20. Positive-electrode current collection plate 34 is electrically connected to positive electrode caps 16 of cells 20 via connection terminals 44 through the openings in positive-side insulating component 38. Negative-electrode current collection plate 36 is also, electrically connected to the negative electrodes of cells 20 via connection terminals (not shown) through the openings in negative-side insulating component 40.

Battery module 100 includes a plurality of battery holders. In the present exemplary embodiment, one battery module 100 includes two battery holders, namely first battery holder 29 and second battery holder 30. The plurality of battery holders are disposed in a predetermined arrangement relation so that the positive electrodes of cells 20 are aligned to one side and the negative electrodes of cells 20 are aligned to the other side. The predetermined arrangement relation is described later. Connection plate 42 interconnects two battery blocks in series.

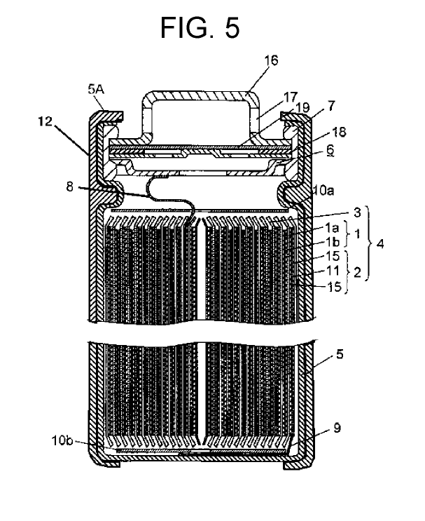

FIG. 5 is a sectional view of cylindrical cell 20. Cell 20 is a chargeable/dischargeable secondary cell. In the present exemplary embodiment, a lithium-ion cell is employed as cell 20. As cell 20, in addition to the lithium-ion cell, a nickel-metal-hydride cell or alkaline cell can be employed. Cell 20 includes electrode group 4 formed by winding positive electrode 1 and negative electrode 2 via separator 3. Positive electrode 1 includes positive electrode lead 8. Negative electrode 2 includes, at its one end, a negative electrode lead facing positive electrode 1. Positive electrode 1 is formed of positive electrode current collector 1a and positive electrode layer 1b that includes a positive electrode active material. Negative electrode 2 is formed of negative electrode current collector 11 and negative electrode layer 15 that includes a negative electrode active material. Insulating plates 10a and 10b are mounted on the upper and lower parts of electrode group 4, and electrode group 4 is inserted into exterior can 5. A non-aqueous electrolyte (not shown) for transmitting lithium ions is injected into exterior can 5. The end of positive electrode lead 8 is welded to seal plate 6. The end of negative electrode lead 9 is welded to the bottom of exterior can 5. Exterior can 5 has a negative potential.

The opening end of exterior can 5 has a structure in which positive electrode cap 16, current blocking member 18, and seal plate 6 are caulked via gasket 7. Positive electrode cap 16 is an electrode portion of the positive electrode. Current blocking member 18 is a positive temperature coefficient (PTC) element, for example. Positive electrode cap 16 is projected from upper surface 5A of the opening end of exterior can 5. Opening portion 17 is disposed on a side surface of positive electrode cap 16. Opening portion 17 is used for exhausting the gas that is generated by the release of ventilation mechanism 19 such as a safety valve due to a failure of electrode group 4.

Heat-shrinkable and insulating resin film 12 is wound on the outer surface of exterior can 5. Resin film 12 keeps the insulation between the battery holder and exterior can 5. As a material of resin film 12, halon can be employed, for example.

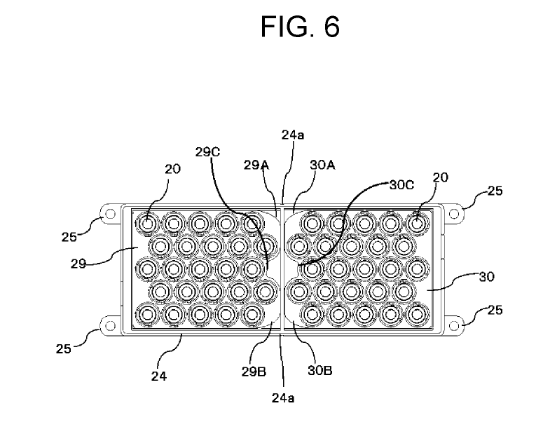

Using FIG. 6, the predetermined arrangement relation of the plurality of battery blocks included in battery module 100 is described. FIG. 6 shows the state where first battery holder 29, second battery holder 30, and cells 20 are stored in lower case 24, and is a top view from the longitudinal direction of the cells.

Each of first battery holder 29 and second battery holder 30 is wholly rectangular in the plan view from the longitudinal direction of cells 20. First battery holder 29 and second battery holder 30 are stored in lower case 24 so that they are adjacent to each other. First battery holder 29 and second battery holder 30 are disposed while a space for securing the insulation between them is kept.

First battery holder 29 includes first cutout portion 29A, third cutout portion 29B, and fifth cutout portion 29C on its one edge facing second battery holder 30. Second battery holder 30 includes second cutout portion 30A, fourth cutout portion 30B, and sixth cutout portion 30C on its one edge facing first battery holder 29. In FIG. 6, first cutout portion 29A and second cutout portion 30A are arranged so as to face each other, third cutout portion 29B and fourth cutout portion 30B are arranged so as to face each other, and fifth cutout portion 29C and sixth cutout portion 30C are arranged so as to face each other. Each of first cutout portion 29A and third cutout portion 29B has a shape that is obtained by cutting each of predetermined corners of the rectangle of first battery holder 29 in the plan view. Each of second cutout portion 30A and fourth cutout portion 30B has a shape that is obtained by cutting each of predetermined corners of the rectangle of second battery holder 30 in the plan view. Fifth cutout portion 29C has a shape obtained by cutting a part of an edge of first battery holder 29, and sixth cutout portion 30C has a shape obtained by cutting a part of an edge of the rectangle of second battery holder 30.

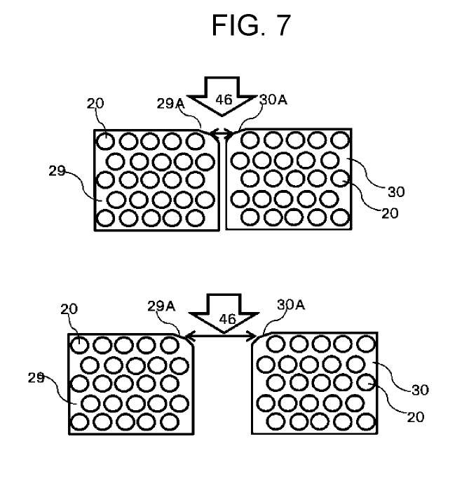

Using FIG. 7 to FIG. 10, the action of the battery holders when an external impact (hereinafter referred to as “external force”) is applied to battery module 100 is described. FIG. 7 to FIG. 10 schematically show the battery holders in the plan view from the longitudinal direction of the cells. First battery holder 29 and second battery holder 30 in FIG. 6 are formed by combining the components in FIG. 7 to FIG. 9.

As shown in FIG. 7, each of first battery holder 29 and second battery holder 30 is wholly rectangular in the plan view. First battery holder 29 includes first cutout portion 29A molded so that the corner formed of one edge facing second battery holder 30 and another edge has a circular arc shape. Second battery holder 30 includes second cutout portion 30A molded so that the corner formed of one edge facing first battery holder 29 and another edge has a circular arc shape. First cutout portion 29A and second cutout portion 30A are disposed so as to be adjacent to each other. When external force 46 is applied to first battery holder 29 and second battery holder 30 from the direction having first cutout portion 29A and second cutout portion 30A, external force 46 vertically applied to first battery holder 29 and second battery holder 30 is dispersed horizontally by first cutout portion 29A and second cutout portion 30A. Therefore, the load charged on first battery holder 29 and second battery holder 30 can be reduced, and the load charged on cells 20 included in each battery holder can be also reduced. The internal short-circuit of cells 20 can be also suppressed.

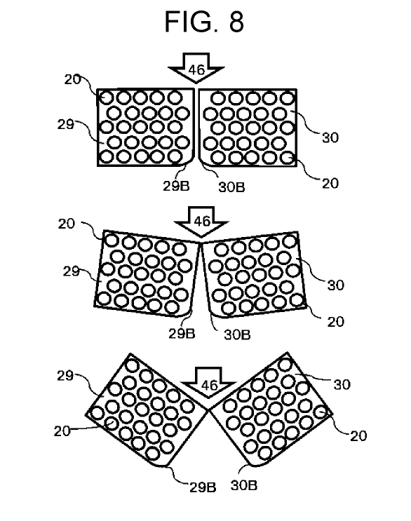

As shown in FIG. 8, each of first battery holder 29 and second battery holder 30 is wholly rectangular in the plan view. First battery holder 29 includes third cutout portion 29B molded so that the corner formed of one edge facing second battery holder 30 and another edge has a circular arc shape. Second battery holder 30 includes fourth cutout portion 30B molded so that the corner formed of one edge facing first battery holder 29 and another edge has a circular arc shape. Third cutout portion 29B and fourth cutout portion 30B are disposed so as to be adjacent to each other. When external force 46 is applied to third cutout portion 29B and fourth cutout portion 30B along the edges of first battery holder 29 and second battery holder 30 that face each other, the balance between first battery holder 29 and second battery holder 30 is broken by third cutout portion 29B and fourth cutout portion 30B, and they come into contact with each other. Then, the vector of external force 46 is shifted in the following direction:

first battery holder 29 and second battery holder 30 move away from each other about, as a fulcrum, the contact between first battery holder 29 and second battery holder 30.

Therefore, the load vertically charged on first battery holder 29 and second battery holder 30 can be reduced, and the load charged on cells 20 included in each battery holder can be also reduced. The internal short-circuit of cells 20 can be also suppressed.

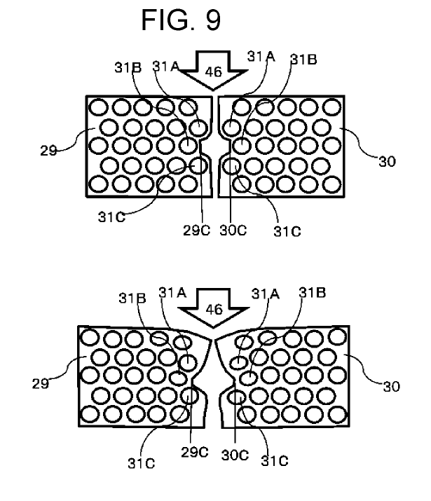

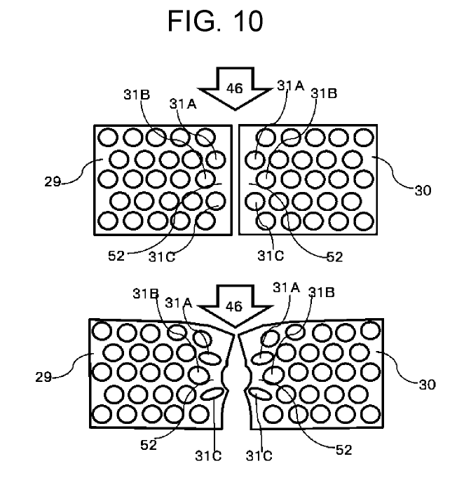

FIG. 9 illustrates the present exemplary embodiment, and FIG. 10 is a reference diagram of FIG. 9. As shown in FIG. 9 and FIG. 10, each of first battery holder 29 and second battery holder 30 is wholly rectangular in the plan view.

In FIG. 9, first battery holder 29 includes fifth cutout portion 29C on one edge facing second battery holder 30, and second battery holder 30 includes sixth cutout portion 30C on one edge facing first battery holder 29. In each battery holder, through holes 31 are arranged in a staggered format. On two of the four edges of the wholly rectangular battery holder, through holes 31 of the battery holder are arranged unevenly. A portion having through hole 31 is a projecting portion, and a portion having no through hole 31 is a recessed portion. In the recessed portions surrounded with through holes 31A, through holes 31B, and through holes 31C, fifth cutout portion 29C and sixth cutout portion 30C are disposed. Fifth cutout portion 29C and sixth cutout portion 30C are disposed so that they face each other.

In FIG. 10, third battery holder 32 and fourth battery holder 33 include no cutout portion. In FIG. 10, a metal as a material of the battery holders exists in recessed portions 52 surrounded with through holes 31A, through holes 31B, and through holes 31C.

When external force 46 is applied to third battery holder 32 and fourth battery holder 33 along the edges of third battery holder 32 and fourth battery holder 33 that face each other, the stress from the metal existing in recessed portions 52 is concentrated on cells 20 held in through holes 31A and through holes 31C. As a result, cells 20 held in through holes 31A and through holes 31C break, and the internal short-circuit can occur.

While, when external force 46 is applied to first battery holder 29 and second battery holder 30 along the edges of first battery holder 29 and second battery holder 30 that face each other, fifth cutout portion 29C and sixth cutout portion 30C can reduce the stress received from the metal existing in recessed portions 52. Therefore, the internal short-circuit of cells 20 held in through holes 31A and through holes 31C can be suppressed.

The present exemplary embodiment is further described on the basis of FIG. 3 to FIG. 5. The height of first battery holder 29 in the longitudinal direction of cells 20 does not need to be a height enough to cover the whole side surfaces of cells 20. Especially, a caulked portion of exterior can 5 of each cell 20 does not need to be covered with the battery holder. The battery holder stores the plane part of the side surface of exterior can 5. As shown in FIG. 5, in cell 20, the caulked portion of exterior can 5 exists at a position where exterior can 5 having a negative potential is close to positive electrode cap 16 having a positive potential.

When a battery holder exists at the level of the caulked portion of exterior can 5, and the battery holder is deformed by an external force, exterior can 5 and positive electrode cap 16 can be short-circuited by the battery holder. When an external force is applied to exterior can 5 via the battery holder, exterior can 5 is deformed, and exterior can 5 and positive electrode cap 16 can be short-circuited. Therefore, the battery holder does not need to cover the caulked portion of exterior can 5.

Cells 20 can be cooled by making a refrigerant such as cold air flow between the battery holder and positive-side insulating component 38.

First battery holder 29 has been described in the above, but the same is true for second battery holder 30.

The present exemplary embodiment is further described on the basis of FIG. 6. In the plan view, the thickness of the metal existing between the rim of first cutout portion 29A and cell 20 near it is greater than that of the metal existing between fifth cutout portion 29C and cell 20 near it. By increasing the former thickness, first battery holder 29 can get rigidity by itself and the crush of first battery holder 29 by an external force can be suppressed. When the latter thickness is increased, the rigidity of the metal existing in the latter part is applied to the cells, and the breakage or internal short-circuit of the cells can be caused. The same is true for second battery holder 30.

Next, thin-wall portion 22a and thin-wall portion 24a are supplemented. Thin-wall portion 22a and thin-wall portion 24a are formed by partially decreasing the thicknesses of upper case 22 and lower case 24, respectively. Thanks to thin-wall portions 22a and 24a, cracks extending from the parts having thin-wall portions 22a and 24a can be caused in the battery case when an external force is applied to the battery case, and hence the places to be broken in the battery case can be adjusted. Because the places to be broken in the battery case can be optionally set, the accident can be suppressed in which a broken member of the battery case accidentally comes into contact with a cell and the cell breaks. Thin-wall portions 22a and 24a may be disposed not on the outer surface of the battery case but on the inner surface thereof.

The exemplary embodiment has described first battery holder 29 and second battery holder 30 each of which includes through holes 31 arranged in a staggered format having five rows and five columns However, the exemplary embodiment of the present invention is not limited to this arrangement. The present invention can be applied to a battery holder in which through holes having a plurality of rows are arranged in a staggered format.

In the exemplary embodiment, the corner of each of first cutout portion 29A, second cutout portion 30A, third cutout portion 29B, and fourth cutout portion 30B has a circular arc shape. The circular arc shape is considered to be optimal for reducing the load vertically charged on first battery holder 29 and second battery holder 30. The corner of each of first cutout portion 29A, second cutout portion 30A, third cutout portion 29B, and fourth cutout portion 30B may have not a circular arc shape but a polygonal shape or a linearly cut shape, in order to reduce the load vertically charged on first battery holder 29 and second battery holder 30.

The exemplary embodiment has described the configuration where two battery holders, namely first battery holder 29 and second battery holder 30, are held in a battery case. However, the exemplary embodiment of the present invention is not limited to this. The present invention can be applied to a battery module where a plurality of battery holders are held in a battery case and the battery holders are disposed so as to face each other.

### INDUSTRIAL APPLICABILITY

A battery block of the present invention is useful as a power source for driving a motor of an electric car or the like or a backup power source or the like.

### REFERENCE MARKS IN THE DRAWINGS

1 positive electrode

1a positive electrode current collector

1b positive electrode layer

2 negative electrode

3 separator

4 electrode group

5 exterior can

5A upper surface

6 seal plate

7 gasket

8 positive electrode lead

9 negative electrode lead

10a, 10b insulating plate

11 negative electrode current collector

12 resin film

15 negative electrode layer

16 positive electrode cap (electrode portion)

17 opening portion

18 current blocking member

19 ventilation mechanism

20 cell

22 upper case

24 lower case

22a, 24a thin-wall portion

25 fixing portion

26 positive electrode terminal

28 negative electrode terminal

29 first battery holder

30 second battery holder

29A, 29B, 30A, 30B, 29C, 30C cutout portion

31 through hole

34 positive-electrode current collection plate

36 negative-electrode current collection plate

38 positive-side insulating component

40 negative-side insulating component

42 connection plate

44 connection terminal

46 external force

52 recessed portion

1. A battery module comprising:
a first battery block including:
a first battery holder having a plurality of through holes; and
a plurality of cells stored in the plurality of through holes, respectively;
a second battery block including:
a second battery holder having a plurality of through holes; and
a plurality of cells stored in the plurality of through holes, respectively; and
a battery case for storing the first battery block and the second battery block so that the first battery block is adjacent to the second battery block,
wherein
the first battery block and the second battery block are stored in the battery case so that a longitudinal direction of the cells stored in the first battery holder and a longitudinal direction of the cells stored in the second battery holder are the same, and
the first battery holder is wholly rectangular in a plan view from the longitudinal direction of the cells,
in the plan view, the first battery holder includes a first cutout portion having a shape, the shape being obtained by cutting a corner formed of a first edge facing the second battery holder and a second edge,
the second battery holder is wholly rectangular in the plan view,
in the plan view, the second battery holder includes a second cutout portion having a shape, the shape being obtained by cutting a corner formed of a first edge facing the first battery holder and a second edge, and
the first cutout portion and the second cutout portion are disposed so as to be adjacent to each other.

2. The battery module according to claim 1, wherein
in the plan view, the first battery holder further includes a third cutout portion having a shape, the shape being obtained by cutting a corner formed of the first edge facing the second battery holder and a third edge different from the second edge having the first cutout portion,
in the plan view, the second battery holder further includes a fourth cutout portion having a shape, the shape being obtained by cutting a corner formed of the first edge facing the first battery holder and a third edge different from the second edge having the second cutout portion, and
the third cutout portion and the fourth cutout portion are disposed so as to be adjacent to each other.

3. The battery module according to claim 1, wherein
the plurality of through holes in the first battery holder are arranged in a staggered format,
the plurality of through holes in the second battery holder are arranged in a staggered format,
the first battery holder includes a fifth cutout portion on the first edge facing the second battery holder and in a region whose three sides are surrounded with through holes, of the plurality of through holes,
the second battery holder includes a sixth cutout portion on the first edge facing the first battery holder and in a region whose three sides are surrounded with through holes, of the plurality of through holes, and
the fifth cutout portion and the sixth cutout portion are disposed so as to face each other.

4. The battery module according to claim 3, wherein
a material of the first battery holder includes a metal, and
in the plan view, a thickness of the metal existing between a rim of the first cutout portion and a cell near the rim, of the plurality of cells, is greater than a thickness of the metal existing between the fifth cutout portion and a cell near the fifth cutout portion, of the plurality of cells.

5. A battery module comprising:
a first battery block including:
a first battery holder having a plurality of through holes; and
a plurality of cells stored in the plurality of through holes, respectively;
a second battery block including:
a second battery holder having a plurality of through holes; and
a plurality of cells stored in the plurality of through holes, respectively; and
a battery case for storing the first battery block and the second battery block so that the first battery block is adjacent to the second battery block,
wherein
the first battery block and the second battery block are stored in the battery case so that a longitudinal direction of the cells stored in the first battery holder and a longitudinal direction of the cells stored in the second battery holder are the same, and
the first battery holder is wholly rectangular in a plan view from the longitudinal direction of the cells,
the plurality of through holes in the first battery holder are arranged in a staggered format,
the first battery holder includes a fifth cutout portion on an edge facing the second battery holder and in a region whose three sides are surrounded with through holes, of the plurality of through holes, the plurality of through holes in the second battery holder are arranged in a staggered format,
the second battery holder includes a sixth cutout portion on an edge facing the first battery holder and in a region whose three sides are surrounded with through holes, of the plurality of through holes, and
the fifth cutout portion and the sixth cutout portion are disposed so as to face each other.

6. The battery module according to claim 1, wherein
the cells stored in the first battery holder are disposed so that storage directions of the cells in the plurality of through holes of the first battery holder are the same,
the cells stored in the first battery holder are cylindrical cells,
an exterior can of each of the cylindrical cells has a caulked portion on a positive electrode side, and
the caulked portion projects from the first battery holder.

7. The battery module according to claim 1, wherein
a material of the first battery holder and a material of the second battery holder include a metal, and
the first battery holder and the second battery holder are disposed at an interval.

8. The battery module according to claim 1, wherein
the battery case includes a thin-wall portion.

9. The battery module according to claim 5, wherein
the cells stored in the first battery holder are disposed so that storage directions of the cells in the plurality of through holes of the first battery holder are the same,
the cells stored in the first battery holder are cylindrical cells,
an exterior can of each of the cylindrical cells has a caulked portion on a positive electrode side, and
the caulked portion projects from the first battery holder.

10. The battery module according to claim 5, wherein
a material of the first battery holder and a material of the second battery holder include a metal, and
the first battery holder and the second battery holder are disposed at an interval.

11. The battery module according to claim 5, wherein
the battery case includes a thin-wall portion.
